(19) United States
(12) Patent Application Publication
(10) Pub. No.: US 2009/0299886 A1
(43) Pub. Date: Dec. 3, 2009

(54) ACTIVITY BASED CREDIT CARD LIMIT ASSIGNMENT

(75) Inventors: Kurt D. Newman, Mathews, NC (US); Timothy J. Bendel, Charlotte, NC (US); Debashis Ghosh, Charlotte, NC (US); David Joa, Pacifica, CA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/128,750

(22) Filed: May 29, 2008

(51) Int. Cl. G06Q 40/00

(52) U.S. Cl. 705/35

(57) ABSTRACT

Systems and methods for reducing the exposure of a financial institution to lending risk. The systems and methods may involve determining a basic credit limit for a customer's new credit card account based at least in part on attributes associated with the customer; assigning an adjusted credit limit to the account; and promising to decide whether to replace the adjusted credit limit with a higher credit limit.

### FIELD OF TECHNOLOGY

Aspects of the disclosure relate to assignment of credit card limits.

### BACKGROUND

A credit limit on a new credit card account is typically based on credit customer attributes collected at the time the account is opened. The attributes may include credit bureau information like accounts, balances, and payment history and other information.

FIG. 1 shows elements 100 of a typical prior art process for assigning a credit limit to a new credit card account. At steps 102, 104 and 106, a credit card application process may be initiated via a pre-approved campaign, an invitation-to-apply campaign or a walk-in event, respectively.

At step 107, the credit card application is received. At step 108, the customer attributes are obtained. At step 110, the application is approved and made ready for the assignment of a credit limit. At step 112, a credit limit is assigned to the account based on the customer attributes. At step 114, the credit card is issued and the account is opened for activity. After the credit card is issued, the issuing financial institution is exposed to the risk of “charge off,” or default, by the customer.

It would be desirable to provide systems and methods to manage, mitigate, limit or reduce a financial institution's risk associated with the opening of a new credit card account.

### SUMMARY OF THE INVENTION

It is an object of this invention to provide systems and methods for managing, mitigating, limiting or reducing a financial institution's risk associated with the opening of a new credit card account. Systems and methods for reducing the exposure of a financial institution to lending risk are therefore provided. The systems and methods may involve determining a basic credit limit for a customer's new credit card account based at least in part on attributes associated with the customer; assigning an adjusted credit limit to the account; and promising to reevaluate, preferably within a predetermined time period, whether to replace the adjusted credit limit with a higher credit limit.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art process;

FIG. 2 illustrates a schematic diagram of a general-purpose digital computing environment in which one or more aspects of the present invention may be implemented; and

FIG. 3 shows a process in accordance with the principles of the invention.

### DETAILED DESCRIPTION OF THE INVENTION

A large number of credit card accounts that eventually “charge off” can be identified within a few months of account opening by examining transactional activity. Accounts with a large dollar amount of transactions in the first few months after account opening have a much higher likelihood of charge off than accounts with more conservative initial activity. Accounts whose balances are never paid may be known as called “first payment defaults.”

There are numerous reasons for the occurrence of a default. In some instances, a default may occur when a financial institution does not screen out an individual who is not credit-worthy. In some instances, a financial institution may issue a card to an individual who has fraudulently misrepresented information on a credit card application. The information may relate to the individual's credit history, assets, identity, or any other such information.

Financial institutions often seek to attenuate the risk of charge off. One method is to decrease a customer's credit limit based on account activity. Credit limit decreases, however, may be classified as “adverse actions.” Adverse action may require justification based on reason codes to ensure that discrimination among customers does not occur. Appropriate “adverse action” reason codes may be difficult to obtain for new accounts. Also, the balance of a high risk account may grow quickly and thus foreclose the opportunity for the financial institution to decrease the credit limit.

Studies show that consumers prefer to obtain and use credit cards with high credit limits. Consumers believe that the authorization to use such relatively higher-limit credit cards may demonstrate that a lending institution has a high level of confidence in the consumers. Even a non-defaulting consumer who has two $5,000 cards and a $12,000 card will choose to use the $12,000 card. Financial institutions, therefore, have a large incentive to offer consumers credit cards that have high credit limits.

A large number of credit card accounts that eventually become delinquent and charge off (are not paid off) are drawn to within a small percentage of their credit limit within the first few months of inception of the account. Some of the accounts have spending nearly equal to the entire assigned credit limit during the first month. High transactional activity during the first few months is a good predictor of accounts that will eventually charge off. High credit limits allow consumers to run up high balances immediately after account opening and, therefore, expose the financial institution to the risk of charge off.

Systems and methods for reducing exposure to lending risk are therefore provided. The systems and methods may involve determining a basic credit limit for the account based at least in part on attributes associated with the customer. The systems and methods may further involve assigning an adjusted credit limit to the account and promising to decide whether to replace the adjusted credit limit with a higher credit limit. The promise may include deciding whether to replace the adjusted credit limit at a predetermined time after the customer opens the account.

The systems and methods may use pre-account-opening customer attributes and/or the first few months of transactional activity of an account to determine the basic and adjusted credit limits. The systems and methods may involve the use of algorithms to evaluate the attributes and/or the transactional activity. The algorithms may be implemented on a computer.

Pre-account opening attributes may include account types, balances, payment history, information available from credit bureaus or any other suitable information.

The basic credit limit may be based on pre-account-opening customer attributes. The adjusted credit limit may be lower or higher than the basic credit limit. The adjusted credit limit may be based at least in part on a percentage of the basic credit limit. The adjusted credit limit may be based at least in part on customer attributes at or before the time the account was opened. The adjusted credit limit may be based at least in part on information from the customer's credit card application, e.g., the amount of credit requested.

In some embodiments of the invention, the system may receive or obtain data relating to the frequency of new credit card account applications and adjusted credit limits. The data may be used to select adjusted credit limits and credit limit adjustment factors that do not unacceptably reduce the frequency of new credit card account applications.

The reevaluation may be scheduled much earlier in the account life cycle than a traditional credit limit evaluation. The financial institution may agree to reevaluate the account for an increase in credit limit after the first few months of activity. The reevaluation may involve the use of algorithms that depend on customer attributes, customer charging behavior or any other suitable attributes. The algorithm may be implemented on a computer.

If, in the first few months after issuance, transactional activity is similar to activity associated with accounts previously observed to charge off, the credit limit on the account may not be increased. Thereafter, if the account charges off, the loss amount will have been reduced.

The increased credit card limit may be based at least in part on customer attributes at or after the time the account was opened. The increased credit card limit may be based on customer transactional behavior after the account was opened. For example, the credit line increase may be greater if the borrower paid promptly or borrowed large amounts and paid promptly. The behavior may include any of the credit customer attributes that were used to evaluate the initial credit line. In some embodiments, the credit line increase may be inversely proportional to an index of the borrower's behavior. For example, the index may be based on number of transactions, frequency of transaction or dollar-value of transactions.

In one example, a financial institution may offer an initial $10,000 credit line (e.g., the adjusted credit limit) with a promise to reevaluate in three months. Upon reevaluation, the credit line may be increased. The increased credit line may be any suitable amount, such as $12,000, $15,000 or more. In some circumstances, the increased credit line may correspond to the basic credit limit. The promise to reevaluate may be viewed as a concession that is made in order to reduce “top end” exposure. (In some circumstances, the top end may be the difference between the initial (or basic) credit limit and the increased (or adjusted) credit limit.)

By undertaking the reevaluation prior to increasing the credit line, the financial institution may save the difference between the adjusted credit line amount (say, $10,000) and the increased credit line amount (say, $12,000) if the account charges off.

Accounts that do not charge off typically have more conservative transaction dollar amounts in the first few months. Customers holding those accounts may be rewarded with increased credit limits. Credit-worthy customers may thus be allowed to progress to higher credit limits at an appropriate rate while the top-end risk from charge off is attenuated.

In some embodiments, the financial institution may establish a criterion upon which the reevaluation is based. For example, the criterion may be the customer's use of a certain fraction of the initial credit limit during an initial time period, such as the first month. The fraction may be any suitable fraction, such as 50%.

Some embodiments of the invention may include a “hard-stop” feature, which may preclude the borrower from being entitled to a credit extension. For example, if the borrower's behavior satisfies a criterion such as spending 50% of the credit limit in the first month, the borrower may be precluded from reevaluation. In some embodiments, such a criterion may be an express term of the credit agreement. In some embodiments, it may not be an express term.

It is contemplated that borrower behavior may shift based on the rewards and consequences applied by the systems and methods of the invention. For example, borrowers who are a first payment default risk may learn to modify early borrowing behavior in order to achieve a higher level of trust with the financial institution. Such a borrower may learn to qualify for a favorable reevaluation. The favorable reevaluation may result in an increased credit limit.

The attributes used as the basis for reevaluation, and the method in which the attributes are applied, may therefore be revised to provide financial institutions with continued risk mitigation even after high-risk borrowers learn to modify their behavior.

The systems and methods may be used in connection with any suitable credit card accounts, including general purpose credit card accounts and store-specific credit card accounts.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

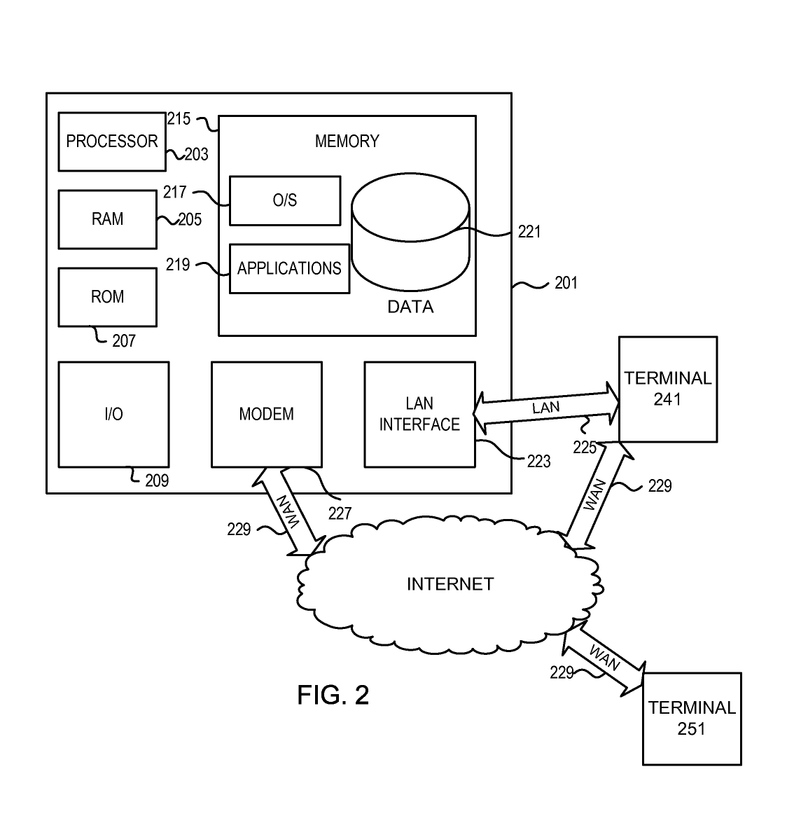

FIG. 2 illustrates a block diagram of a generic computing device 201 (alternatively referred to herein as a “server”) that may be used according to an illustrative embodiment of the invention. The computer server 201 may have a processor 203 for controlling overall operation of the server and its associated components, including RAM 205, ROM 207, input/output module 209, and memory 225.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 225 and/or storage to provide instructions to processor 203 for enabling server 201 to perform various functions. For example, memory 225 may store software used by server 201, such as an operating system 217, application programs 219, and an associated database 221. Alternatively, some or all of server 201 computer executable instructions may be embodied in hardware or firmware (not shown). As described in detail below, database 221 may provide storage for account information, account holder information, account application data and statistics, and any other suitable information.

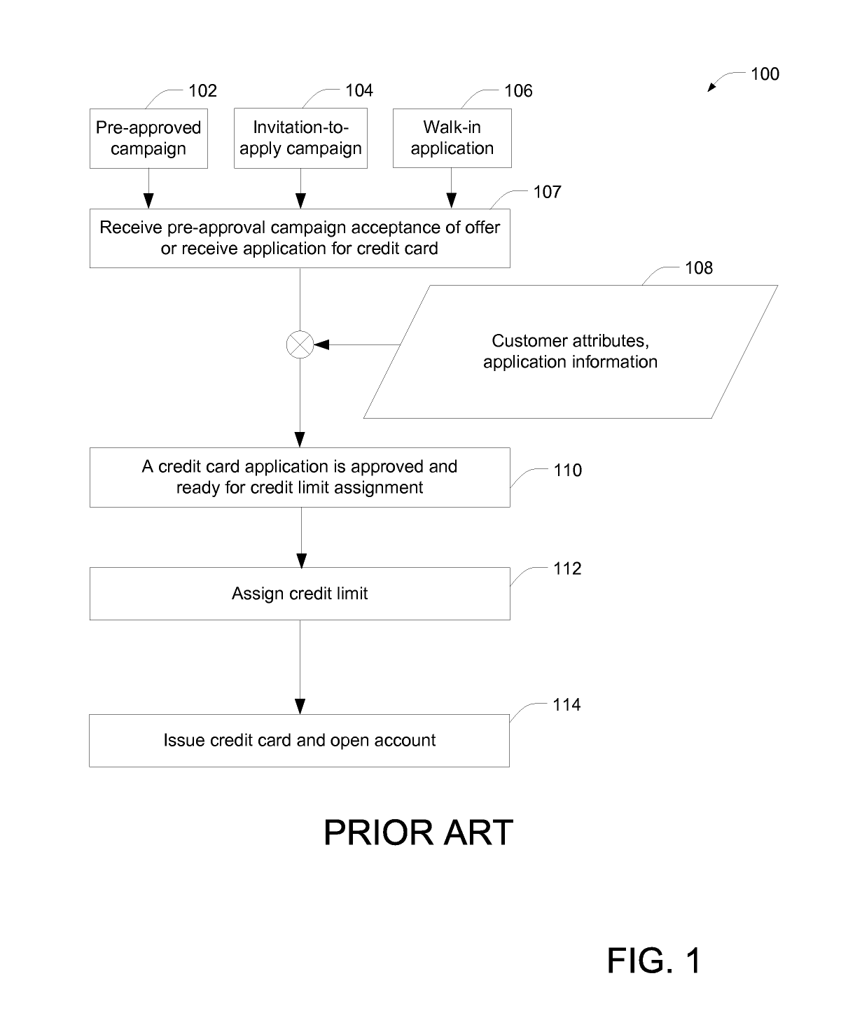

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 1 include a local area network (LAN) 225 and a wide area network (WAN) 229, but may also include other networks. When used in a LAN networking environment, computer 201 is connected to LAN 225 through a network interface or adapter 223. When used in a WAN networking environment, server 201 may include a modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown).

A financial institution may use a terminal such as 241 or 251 to communicate with a customer about an application for a credit card account. Customer attribute information, including credit application information, may be stored in memory 225. The attribute information may be processed by an application such as one of applications 219.

One or more of applications 219 may include an algorithm that may be used to determine a basic credit limit, an adjusted credit limit, an increased credit limit or any other suitable credit limit. The application may include functions for outputting the credit limits and for tracking dates and times for reevaluating credit limits. The application may include functions for communicating credit limit and date information to financial institution agents, customers or any other suitable party.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

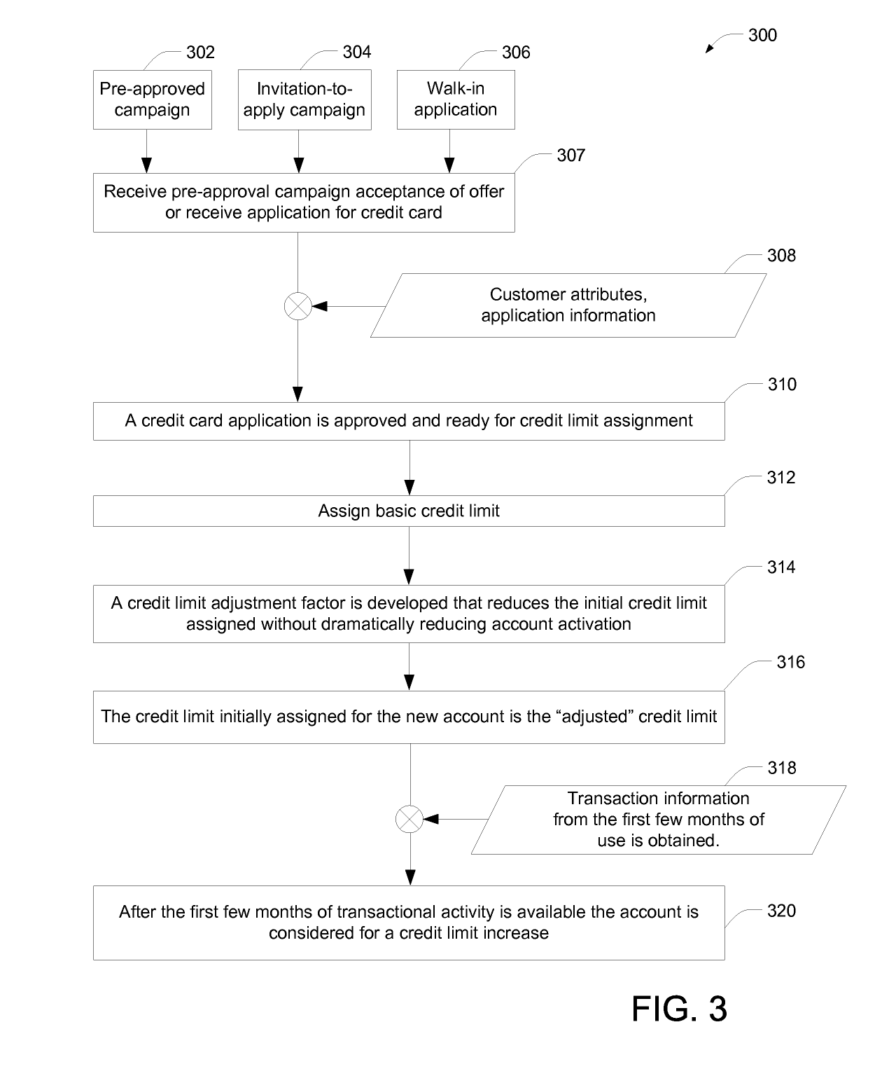

FIG. 3 shows illustrative process 300 for reducing exposure to lending risk. For the sake of illustration, process 300 will be described as being performed by a system. The system may include one or more of the devices shown in FIG. 2, one or more individuals and/or any other suitable device or approach.

At steps 302, 304 and 306, a credit card application process may be initiated. The process may be initiated via a pre-approved campaign (step 302), an invitation-to-apply campaign (step 304) or a walk-in (step 306). The system may include features for conducting one or both of campaigns 302 and 304.

At step 307, the system may receive a customer's acceptance of a pre-approval campaign (step 302) offer. At step 307, the system may receive an application for a credit card account (steps 304 or 306). The system may obtain a credit card application from any suitable source or using any suitable method or device.

At step 308, customer attributes may be obtained. The customer attributes may be collected by the system, or by devices or individuals outside of the system, and stored in memory 115 (shown in FIG. 1), for example. At step 310, the system may approve the application for a credit card account.

At step 312, the system may assign a basic credit limit to the account. At step 314, the system may develop a credit limit adjustment factor. The credit limit adjustment factor may be used to calculate an adjusted credit limit that is lower than the basic credit limit. At step 316, an adjusted limit may be assigned to the account. The adjusted limit is the initial limit for the account. At step 318, account activity data may be received or obtained. The account activity data may correspond to a first period of activity in the account. The period may be any suitable period, such as a month, a number of weeks or a quarter. At step 320, the account may be reevaluated for a credit limit increase. The reevaluation may be based on account activity data from step 318. The reevaluation may be based on customer attribute data from step 308. The credit limit may be increased to the basic credit limit or to any other suitable credit limit.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for reducing exposure to lending risk have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for reducing exposure to lending risk, the method comprising:
receiving from a customer an application for a credit card account;
determining a basic credit limit for the account based at least in part on attributes associated with the customer;
assigning an adjusted credit limit to the account;
offering the account to the customer; and
transmitting an agreement to evaluate whether to replace the adjusted credit limit with a higher credit limit, the replacement to take place no later than a fixed time after issuance of the credit card.

2. The method of claim 1 wherein the assigning comprises formulating the adjusted credit limit based on the basic credit limit and a credit limit adjustment factor.

3. The method of claim 2 further comprising selecting the credit limit adjustment factor based at least in part on data related to account activation frequency.

4. The method of claim 2 further comprising selecting the credit limit adjustment factor based at least in part on the basic credit limit.

5. The method of claim 2 further comprising selecting the credit limit adjustment factor based at least in part on a customer attribute.

6. The method of claim 1 wherein the higher credit limit is the same as the basic credit limit.

7. The method of claim 1 wherein the fixed time is not more than about six months.

8. The method of claim 1 wherein the fixed time is not more than about three months.

9. The method of claim 1 wherein the fixed time is not more than about one month.

10. The method of claim 1 further comprising determining whether to replace the adjusted credit limit with the higher credit limit.

11. The method of claim 10 further comprising replacing, at a time no later than the fixed time, the adjusted credit limit with the higher credit limit.

12. A system for reducing exposure to lending risk, the system comprising:
a memory module;
a processor in electrical communication with the memory module; and
a communication module in electrical communication with the processor; wherein:
the memory module comprises customer attribute data; and
the processor is configured to combine the customer attribute data with a basic credit limit to produce an adjusted credit limit.

13. The system of claim 12 wherein the communication module is configured to receive an application for a credit card account.

14. The system of claim 13 wherein the processor is further configured to select a basic credit limit based on the application and the customer attribute data.

15. The system of claim 12 wherein the processor is further configured to assign the adjusted credit limit to the account.

16. The system of claim 12 wherein the processor is further configured to communicate, via the communication module, information comprising an account number corresponding to the account, the adjusted credit limit, and an offer to replace the adjusted credit limit with a higher limit no later than a fixed time after the account is activated.

17. The system of claim 16 wherein the offer is a conditional offer.

18. The system of claim 17 wherein the processor is further configured to:
analyze at least one supplemental customer attribute; and
based on the attribute, select an increased credit limit.

19. The system of claim 18 wherein the supplemental customer attribute includes activity information corresponding to the account.

20. The system of claim 16 wherein the fixed time is not more than about six months.

21. The system of claim 20 wherein the fixed time is not more than about three months.

22. The system of claim 21 wherein the fixed time is not more than about one month.

23. A computer-readable medium storing computer-executable instructions which, when executed by a processor on a computer system, perform a method for reducing exposure to lending risk, the method comprising:
receiving from a customer an application for a credit card account;
determining a basic credit limit for the account based at least in part on attributes associated with the customer;
assigning an adjusted credit limit to the account;
offering the account to the customer; and
electronically transmitting an agreement to decide whether to replace the adjusted credit limit with a higher credit limit, the replacement to take place no later than a fixed time after the customer opens the account.

24. The medium of claim 23 wherein assigning comprises formulating the adjusted credit limit based on the basic credit limit and a credit limit adjustment factor.

25. The medium of claim 24 further comprising at least one instruction for selecting the credit limit adjustment factor based at least in part on data related to account activation frequency.

26. The medium of claim 24 further comprising at least one instruction for selecting the credit limit adjustment factor based at least in part on the basic credit limit.

27. The medium of claim 24 further comprising at least one instruction for selecting the credit limit adjustment factor based at least in part on a customer attribute.
